(19) United States
(12) Patent Application Publication
(10) Pub. No.: US 2003/0145087 A1
(43) Pub. Date: Jul. 31, 2003

(54) Generating a list of addresses in a server

(76) Inventors: S. Brandon Keller, Evans, CO (US); Gregory D. Rogers, Fort Collins, CO (US); George H. Robbert, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/062,210

(22) Filed: Jan. 31, 2002

(51) Int. Cl. G06F 15/16; G06F 7/00; G06F 15/173

(52) U.S. Cl. 709/226; 709/245; 707/10

(57) ABSTRACT

When an operator enters a partial address into a browser, the browser displays at least one full address, where the displayed address may be an address that has not been previously entered into the browser or accessed by the browser.

### FIELD OF INVENTION

This invention relates generally to computer networks.

### BACKGROUND OF THE INVENTION

The Internet is a collection of interconnected computers, and the World Wide Web (WWW, or Web) is a collection of logically linked electronic documents, available over the Internet. Each document has a unique address, called a Uniform Resource Locator (URL), which includes a name of a server. When a URL is entered in a Web browser, the browser software sends the URL over the Internet, where it is routed to the named server (or a proxy), and the named server (or proxy) sends the document back to the browser, where it is displayed by the computer running the browser. There may be multiple intermediate servers, routers, and switches involved in locating the named server and retrieving the document.

URL's may be relatively long, for example on the order of several hundred characters, and may include multiple abstract combinations of characters. As a result, it may be difficult for a human operator to memorize all the URL's of interest to the operator. Browsers may provide some assistance. For example, browsers may cache addresses that have been previously entered into the browser. When an operator starts typing a URL, the browser may display to the operator a previous address that includes the partial address. The operator may then press a key that causes the browser to select the displayed previous address, thereby automatically completing the address for the operator. If there is more than one address that includes the partial address, the browser may display a list of previous addresses, and the operator may select one address from the list.

There is an ongoing need for improved assisted entering of addresses.

### SUMMARY OF THE INVENTION

In an example embodiment, when an operator types or otherwise enters a partial address into a browser, the browser displays at least one full address, where the displayed address may be an address that has not been previously entered into the browser or accessed by the browser.

### BRIEF DESCRIPTION OF THE DRAWINGS

FIG. 1 is a block diagram of an example system in which the invention may be implemented.

FIG. 2 is a flow chart illustrating an example embodiment of a browser with assisted completion of addresses.

FIG. 3 is a flow chart illustrating a first example embodiment of generating a list of addresses for use by a browser for assisted completion of addresses.

FIG. 4 is a flow chart illustrating a second example embodiment of generating a list of addresses for use by a browser for assisted completion of addresses.

FIG. 5 is flow chart illustrating a third example embodiment of generating a list of addresses for use by a browser for assisted completion of addresses.

FIG. 6 is a flow chart illustrating a fourth example embodiment of generating a list of addresses for use by a browser for assisted completion of addresses.

FIG. 7 is a flow chart illustrating a fifth example embodiment of generating a list of addresses for use by a browser for assisted completion of addresses.

FIG. 8 is a flow chart illustrating an example embodiment of a method for a browser in an environment in which all of the example embodiments of generating a list of addresses have been implemented.

### DETAILED DESCRIPTION OF THE PREFERRED EMBODIMENT OF THE INVENTION

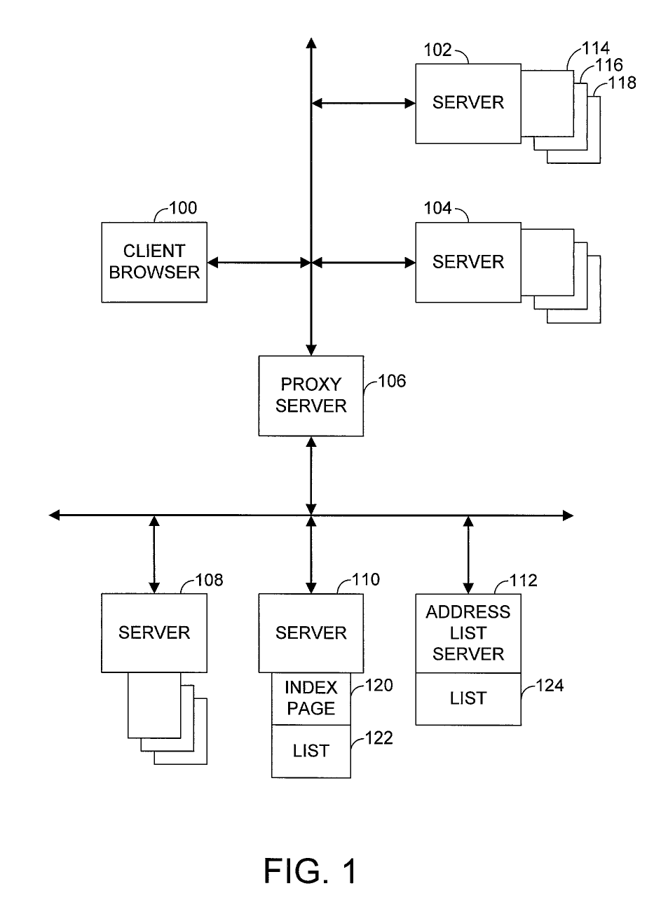

FIG. 1 illustrates a collection of interconnected computers, which may be dispersed over the Internet, or may be configured as a local area network, or both. The interconnections may be wired or wireless. A client browser application 100 can communicate with servers (102-112).

For the World Wide Web, documents are written in a plain-text platform-independent format called HyperText Markup Language (HTML). HTML documents include elements, where elements may include text, images, sound, interactive controls, formatting instructions, and URL's for other documents. A WEB page is an HTML document. A WEB site is a collection of documents, including a document called an index page (also known as a home page), which in turn links to other documents. Each Web server may have a tree-structured hierarchy of HTML documents, starting with links from the index page. For example, in FIG. 1, server 102 is depicted as having an index page 114, which in turn includes an address for a second document 116, which in turn includes an address for a third document 118. Servers 104 and 108 are also depicted as having a hierarchy of documents.

It is common in Web environments to provide a server, called a proxy server, between a client application, such as Web browser, and a Web server having a document to be read by the Web browser. A proxy server, among other things, may cache a requested document. If a second client then requests a previously requested document, the proxy server will then provide the document, which typically improves performance. A proxy server may also permit browsers from within a firewall to access the Web while denying external access to systems inside the firewall. In FIG. 1, document requests from the client 100 may be routed through a proxy server 106, and then if necessary to servers 108, 110, and 112.

In the following discussion, a reference to a browser includes software adapted in work in conjunction with a browser. That is, changes to a browser may be implemented as changes to the browser software itself, or may be implemented as a plug-in that works with the browser. For example, a plug-in may provide an additional window for entry of an address, and a plug-in may provide various displays in conjunction with entering an address.

There are multiple example aspects to the invention, which may be implemented independently, or in various combinations. In a first example aspect, when an operator, using client browser software, enters a partial address, the client browser software displays a list of full addresses for possible use by the operator. In contrast to prior systems, a client browser in accordance with one example aspect of the invention may display full addresses that have never been previously requested or entered by an operator of the client software. That is, a prior request by an operator is not required. In other example aspects of the invention, multiple example alternatives are provided for how a list of full addresses may be generated.

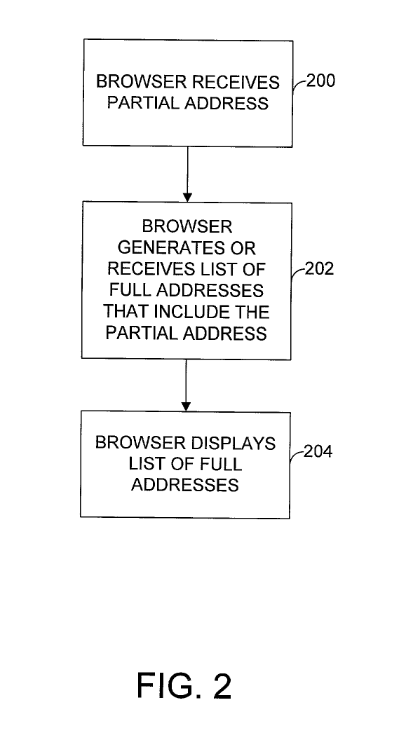

FIG. 2 illustrates one example aspect of the invention. At step 200, a browser receives part of an address. The address may or may not include the name of a server.

At step 202, the browser may generate a list of full addresses, or the browser may receive a list of full addresses. The list may have been stored in memory by the browser when processing an earlier address entry. The list may be generated by the browser in response to a pending address entry. The list may be provided by a server or by a document. In general, the list may include addresses that were not previously entered by an operator of the browser.

At step 204, the browser displays the list of full addresses (or a subset of the list, as will be discussed in more detail later). The operator may then select one of the full addresses, or may continue to enter additional characters of the partial address.

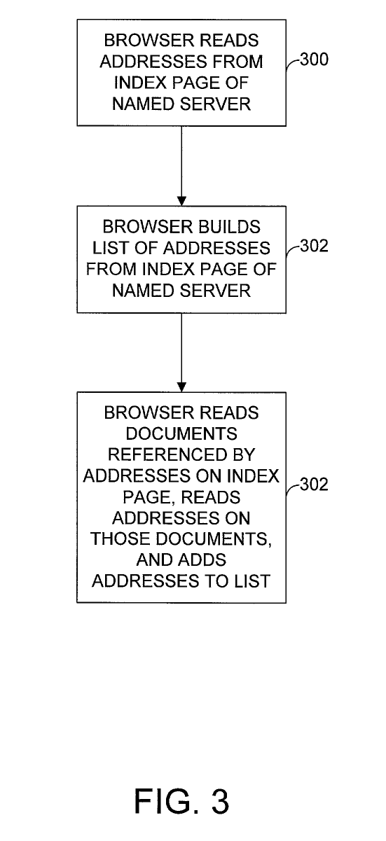

FIG. 3 illustrates a first example embodiment of a method for generating a list of addresses for use by a browser to assist entry of addresses. In the example of FIG. 3, the browser generates the list. The method of FIG. 3 assumes that a browser has received a partial address that at least includes the name of a server. At step 300, the browser reads at least the index page from the named server, and extracts a list of URL's included in the document. HTML elements are identified by tags (denoted by a left angle bracket (<), a tag name, and a right angle bracket (>). One particular tag is <a>, which stands for anchor. An anchor is a link to another document. Links may include URL's. For example, the following set of characters, within an HTML document, designates a URL:

<a HREF=“http://www.servername.com”>

Browser software commonly includes software for recognizing URL's. For example, when displaying text, browsers commonly present URL's as underlined and in a distinctive color. In addition, many text editors include software for recognizing URL's.

At step 302, the browser builds a list of addresses from the addresses extracted from the index page of the named server.

At step 304, the browser may optionally read deeper into the hierarchy of documents on the named server. That is, the browser may read the documents referenced by the addresses on the index page, and extract URL's from each of those documents. As a result, the browser may build a tree-structured hierarchy of addresses.

For an example application of the method of FIG. 3, for the system in FIG. 1, an operator may type, into browser 100, the name of server 102. The browser 100 may then extract from document 114 all the URL's included in document 114, including a URL for document 116. The browser may then read document 116, and extract a URL for document 118. The browser may then build a hierarchical list of full addresses found on server 102. The browser may display at least part of the list to the operator. The browser may also save the list for future use.

The browser may display only addresses that include the partial address. The displayed list may be limited to the index page, or may be extended to a hierarchy. The operator may choose a full address from the displayed list. The operator may navigate through the displayed list, exploring deeper into the hierarchy. If additional characters are added by the operator, the browser may display only the addresses that include the additional characters. At any point, the operator may select a full address from a displayed list, or the operator may continue to add additional parts of the address to reduce the size of the displayed list. For example, after typing “servername/abc”, the browser may present a hierarchy containing 100 full addresses that include “servername/abc”, and the operator may then navigate through the hierarchy, or may simply add additional characters to reduce the size of the presented hierarchy.

In the example method of FIG. 3, the only documents that are added to the list are those that are included in a hierarchy of documents linked from document URL's included in the index page of a named server. In general, a computer may have some HTML documents that are linked to an index page, and may have other HTML documents that are not linked to an index page, or may have other HTML documents with restricted access. In a controlled environment, with controlled access, it may be acceptable for an operator to have more extensive access to HTML documents.

In FIG. 1, client 100 and servers 102 and 104 may be on a local network. At least one of servers 102 and 104 may include a Web file location map, which is a list of directories indexed by server name, which identifies every Web server file system on the local area network. Server names may be discovered automatically, but names of Web servers, and in particular location of Web file systems, may need to be maintained by a site administrator. A server with access to the Web file location map (that is, the server generating an address list is not necessarily the same server that has the Web file location map) may then search directories and sub-directories in the file systems identified by the Web server location map for HTML documents, and create a hierarchical list of addresses for those documents. Presently, HTML documents can be identified by one of three file name suffix's: .htm, .html, and .shtml. Alternatively, the browser may read the Web file location map, and the browser may generate a document list for local servers. Note that the resulting document address list may include documents that are not discoverable by starting with a index page. For example, some documents may still be in the process of being developed, and are not yet referenced in other documents. Note that the server (or browser) that generates the document address list may periodically or repeatedly refresh the list, adding addresses, verifying that all addresses in the list are valid, and deleting addresses that are no longer valid. The client browser needs to know the name of at least one server that has the Web file location map, or the name of at least one server that generates and stores the document address list. Then, when a partial address is entered into the client that includes the name of a local server, if the client does not have the document address list for the named local server, the client may go to a server on the local network (which may be a different server than the server identified by the entered partial address) and retrieve the entire document address list, or at least addresses that include the entered partial address. Addresses in the list that include the entered partial address may be displayed. The client may also save the list for future use. The operator may navigate through the displayed list, or may enter additional characters to reduce the size of the displayed list.

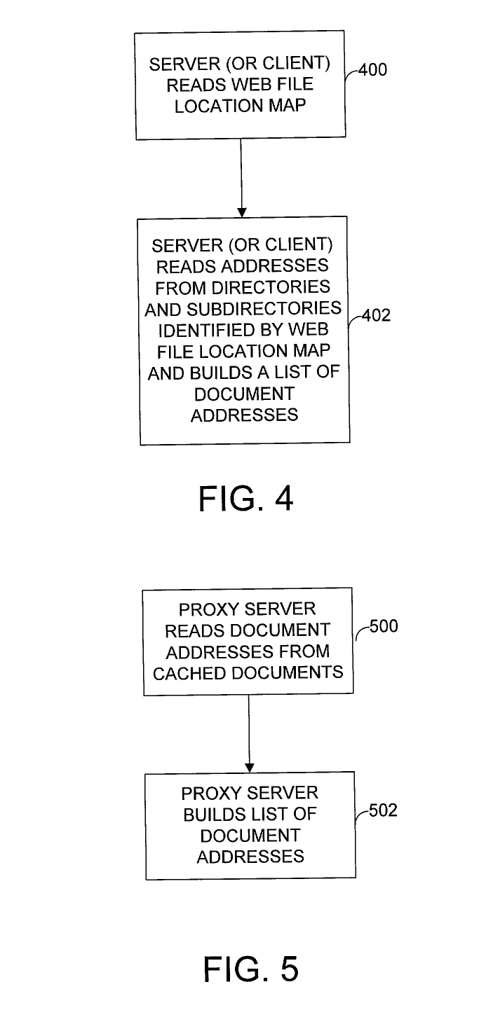

FIG. 4 illustrates an example of a process for a server for generating an address list for use in assisting entry of addresses. At step 400, a server running list building software, reads a Web file location map from a server (which may be the same server or a different server). At step 402, the server running the list building software reads HTML document addresses from directories and subdirectories identified by the Web file location map, and builds a list of document addresses.

FIG. 5 illustrates an alternative example method in which a proxy server (for example, FIG. 1, 106) is used to generate a list of document addresses. At step 500, a proxy server reads its cached documents. For each document, it reads URL's contained in the document. Optionally, it may read the documents referenced by those URL's, and read addresses from those documents, and so forth. As a result, at step 502, the proxy server accumulates a hierarchical list of addresses based on previous addresses sent to the proxy server. If the proxy server has not previously cached an address hierarchy, the proxy server may read the index page of the named server and provide the addresses as read in real time. The proxy server may periodically or repeatedly refresh the list, adding URL's, verifying that all URL's in the list are valid, and deleting URL's that are no longer valid.

An alternative example method for generating a list of document addresses is to program a server to mine the Web and generate a list of document addresses. The list may optionally be offered as a for-fee service, or as a service subsidized by advertising. An address list server (for example, FIG. 1, 112) may mine the Web for document addresses. For example, there are search engines (sometimes called Web crawlers) that search the web and provide a searchable data base. Examples include Google, Overture, NBCi, Lycos, LookSmart, and AskJeeves. In addition, browsers offer searchable databases. An example tool that can be used to automatically gather hierarchies of documents is the Linux “wget” command, which can be used to copy multiple levels of documents for indexing and searching. One example of how an address list server can mine the Web is to search every server name requested. That is, if an operator sends a partial address including a server name, the web mining server can save the server name in memory for future use and search the named server for document addresses. A second way an address list server can mine the Web is to generate sequential or random Internet Protocol (IP) addresses, and see if there is a Web server at a specific port number. Web servers are commonly at port 80. If a Web server responds at port 80 of a sequential or random IP address, the IP address can be saved for future use and the Web server can be searched for document addresses. A third way in which an address list server can obtain lists of addresses is to buy address lists from others, or the sell the right to have others include address lists on the address server.

In contrast to a method in a local network server, as in FIG. 4, which searches for all HTML document addresses in directories and subdirectories, and a method in a proxy server, as in FIG. 5, which searches for URL's referenced in cached documents, an address list server may actively search the entire Web to discover valid URL's and to extract URL's, or obtain lists from others. In contrast to the existing search engines, an address list server only needs to build a data base of addresses (not contents of those addresses). Note, however, that an address list service may be in conjunction with a more general search engine. Note in addition that a proxy server typically provides the actual requested documents, whereas an address list server may only provide a list of addresses.

As an example of using a address list server, a browser operator may request a dialog box, with an entry area for an address, that expressly indicates that the partial address will be sent to an address list server. The operator may enter a partial address, and then press a key or click on a function that causes the browser to send the partial address to the address list server. The list server may then respond with a list of addresses that include the partial addresses. As with any response to a Web search request, the number of matching URL's may be large, and there may need to be ways to organize or prioritize the matching URL's. Possible methods of prioritizing the matching URL's include ordering them in order of most-frequently-used, or most-recently-used.

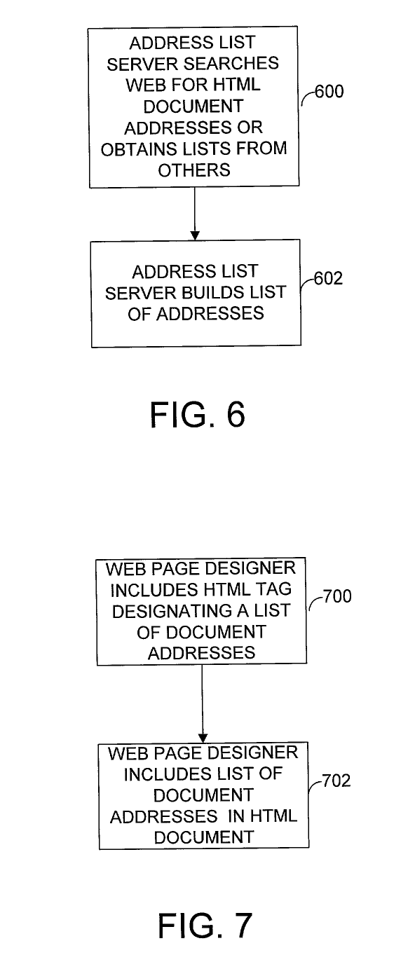

FIG. 6 illustrates an example method for building an address list using an address list server. At step 600, the address list server searches the Web for HTML document addresses or obtains lists from others. At step 602, the address list server builds a list of the discovered or obtained addresses.

An alternative example method for generating a list of document addresses is to expressly incorporate a list of addresses in an index page or other HTML document. For example, for many commercial Web sites, it is in the interest of the owner of the Web site to facilitate and streamline navigation to the ultimate document of interest. A unique identifier may be specified for use within a comment area designated by an HTML comment tag, and the unique identifier in turn may designate a document address list. Making the address list part of a comment prevents the list from being displayed unless the raw HTML file is being displayed as source text. The list may be an optional part of the design of a Web page. When a partial address is entered that includes the name of a server, the browser may go to the server, and instead of searching for URL's, as in FIG. 3, the browser may search for the unique identifier designating a document address list, and read the contents of the list.

FIG. 7 illustrates an example method for building an address list within and HTML document. At step 700, a Web page designer includes a unique identifier that designates a list of document addresses. At step 702, the Web page designer includes the list of addresses in the HTML document.

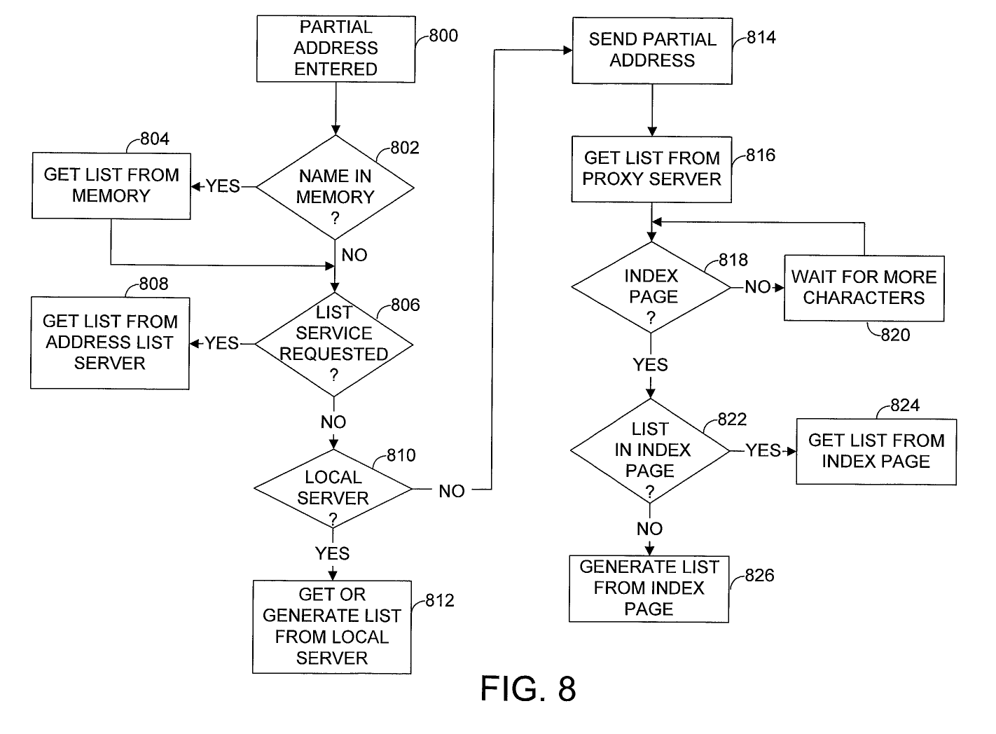

Each of the above example alternatives for generating a list may be implemented independently, or they may implemented in any combination. FIG. 8 illustrates a global method for a browser in an environment in which all the example alternatives for generating a list have been implemented. At step 800, a partial address has been entered, which may or may not include the name of a server. The browser may have generated or received an earlier document address list, which it has stored in memory. Note also that the browser may merge multiple lists, and save them in memory. If the browser has a stored list, then at step 802, the browser retrieves its stored list. Even if there is a stored list, the browser may display any addresses in that list that include the partial address, and then proceed to other methods to get even more addresses, or to refresh the list in memory.

At step 806, if the browser expressly requests assistance from an address list server, then at step 808 the partial address is sent to an address list server and the address list server responds with a list of addresses.

At step 810, the browser checks to see if the partial address includes a fully qualified local server name. A URL has the following syntax: scheme://host.domain/path/filename. For a document on a Web server, the scheme is “http” (HyperText Transfer Protocol). Examples of domains are .com, .org, .net, .edu, and .gov. In general, in order for a client to find a host server anywhere on the Internet, the host name must be registered. For example, hp.com is a registered domain name for Hewlett-Packard Company. Local network server addresses may not be registered. For example, ab.ce.ef.hp.com may represent the name of a local unregistered server, which is accessible behind a firewall for hp.com, but not accessible from outside Hewlett-Packard Company without permission. Accordingly, at step 810, if the partial address includes a fully qualified server name of the form “http://www.xx.xx.host.domain”, where there may or may not be additional characters after the domain, then at step 812 the browser will request an address list from server xx.xx.host.domain. Alternatively, the browser may access the Web file location map, and generate an address list from the file locations given for server xx.xx.host.domain.

At step 810, if the partial address is not a local server name, then at step 814 the browser may send the partial address over the Internet. If the partial address goes to a proxy server, then at step 816 the proxy server may return an address list. If the partial address is the complete address for an index page, the proxy server may also return an index page. At step 818, if the partial address is not the complete address for an index page, then at step 820 the browser must wait for additional characters before it can look for address information on an index page.

At step 822, the browser searches an index page to see if the index page includes an address list. If the index page includes an address list, then at step 824 the browser gets the address list from the index page. If there is no address list on the index page, then at step 826 the browser builds an address list from the index page.

At any point in the method illustrated in FIG. 8, if the browser is already displaying multiple full addresses, the browser may decide to exit the method. For example, if an address list is obtained from memory in step 804, the browser may exit at that point. Similarly, if an address list is obtained from a list server at step 808, the browser may exit at that point, and so forth. In particular, at step 820, if the browser is already displaying multiple full addresses, the browser may choose to exit the method and not wait for more characters.

Note, in each of the above example embodiments and variations, the browser presents a list or hierarchy of full addresses available to the operator, even though the browser may have never previously accessed the server. The browser may merge multiple lists and save the merged list. The operator may choose a full address from the displayed list. The operator may navigate through the displayed list, exploring deeper into the hierarchy. If additional characters are added by the operator, the browser may display only the addresses that include the additional characters. At any point, the operator may select a full address from a displayed list, or the operator may continue to add additional parts of the address to reduce the size of the displayed list.

What is claimed is:

1. A method for generating a list of addresses, comprising:
sending, by a server, an internet protocol address;
receiving, by the server, a document;
reading, by the server, at least one document address from the document; and,
writing, by the server, the document address in a list of document addresses.

2. The method of claim 1, further comprising:
receiving, by the server, a second list of addresses from a second server; and,
writing, by the server, the second list of addresses to the list of document addresses.

3. The method of claim 1, further comprising:
sending, by the server, the list of document addresses, to a client, in response to a request from the client.

4. The method of claim 3, further comprising:
charging a fee for sending the list of document addresses to the client.

5. The method of claim 3, further comprising:
sending, to the client, advertising; and,
charging a fee for sending advertising to the client.

6. A server, comprising:
a processor;
a memory medium, readable by the processor, containing a program to instruct the processor to perform the following method:
sending an internet protocol address;
receiving a document;
reading at least one document address from the document; and,
writing the document address in a list of document addresses.

7. A computer readable medium, containing a program to perform the following steps:
sending, by a server, an internet protocol address;
receiving, by the server, a document;
reading, by the server, at least one document address from the document; and,
writing, by the server, the document address in a list of document addresses.

8. A server, comprising:
means for sending an internet protocol address;
receiving a document;
reading at least one document address from the document; and,
writing the document address in a list of document addresses.
